(19) United States
(12) Patent Application Publication
(10) Pub. No.: US 2009/0327438 A1
(43) Pub. Date: Dec. 31, 2009

(54) AUTOMATICALLY CREATING CONTACT GROUPS AND FOR SUGGESTING AN E-MAIL SENDING LIST

(75) Inventors: FU CHENG, BEIJING (CN); XINSHENG MAO, BEIJING (CN); SONG WEI SHAN, BEIJING (CN); JUN ZHANG, BEIJING (CN)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES PARK, ARMONK, NY (US)

(21) Appl. No.: 12/469,832

(22) Filed: May 21, 2009

(30) Foreign Application Priority Data
Jun. 27, 2008 (CN) 200810131944.7

(51) Int. Cl. G06F 15/82

(52) U.S. Cl. 709/206

(57) ABSTRACT

There is provided a solution for automatically creating contact groups, a method of the solution comprising: tracking an email sending history of a user, and automatically recording email sending data, wherein the recorded email sending data comprises contact groups, each of which consists of the email addresses and all the receivers of a sent email and corresponding receiving types. There is further provided a solution for suggesting an email sending list to a user, a method of the solution comprising: retrieving one or more contact groups from the recorded email sending data when the user composes a new email; and, presenting to the user the retrieved one or more contact groups as possible sending lists.

### CROSS-REFERENCE TO RELATED APPLICATIONS

This application claims the benefit of Chinese Patent Application No. 200810131944.7 filed 27 Jun. 2008, entitled “A Method to Facilitate User Sending Emails by Suggesting a List of Multiple Receivers Through Tracking Usage History”, which is assigned to the assignee of the present application, and the teachings of which are hereby incorporated by reference in their entirety.

### BACKGROUND

The present invention relates to data communications, particularly to email sending, and more particularly, to automatically creating contact groups and to suggesting an email sending list.

As emails have become part of daily work and life of people, how to conveniently and quickly compose emails, including rapidly inputting the receivers' addresses without error, has drawn the attention of people.

In contrast to the conventional method in which the user sending an email directly inputs the email address of each receiver, some existing email clients may, when a user is inputting an email address, provide to the user an email address or contact name list, thus the user can select the needed email addresses therefrom. For example, when a user is entering an email address, an email client application may select, based on the letter(s) the user has keyed in, from a contact list and list of email addresses or contact names beginning with the letter(s) keyed in, for the user to select therefrom. As another example, in some other existing technical solutions, when the user has input a receiver, other users having appeared in a same sending list as that of the receiver are searched for in mail sending history records, and the other users are ordered and provided to the user as a possible additional receiver list for the user to select any additional receiver(s) therefrom.

While the above method can increase the efficiency that a user inputs receiver email addresses and lower error rate to some extent, it still requires the user to input or select each receiver email address or contact one by one, so the efficiency is still to be increased, and the user may select a wrong contact name or email address especially when there exist contacts having identical or similar names or email addresses.

Most of the existing email clients allow a user to create communication groups, each of which comprise the email addresses of several contacts, and have a group name. Thus, when the user composes an email, he can select a pertinent group name as a receiver to send the email to all the contacts included in the communication group. While such a method can also increase the efficiency of inputting receiver email addresses to some extent, it requires that the user creates in advance and dynamically maintains each communication group. When the members in communication groups change frequently for work-related reasons, etc., the cost for the user to maintain the communication groups is high. Further, due to the dynamic nature of daily work, it is not appropriate to create a communication group for many email receivers. For example, the created communication group may seldom be used or the created communication group only includes a few contacts, thus is not worth being created. In addition, a further defect of such a method is that, when a user uses a communication group, he can only see the name of the group and cannot see the names or email addresses of the group members, thus when the content of the communication group is outdated, the user is not informed of this, thus causing inconvenience and possible mistakes.

### SUMMARY

According to an aspect of the present invention, there is provided a method for automatically creating contact groups, comprising: tracking an email sending history of a user, and automatically recording email sending data, wherein the recorded email sending data comprises contact groups, each of which consists of the email addresses of all the receivers of a sent email and corresponding receiving types.

According to another aspect of the present invention, there is provided a method for suggesting an email sending list to a user, comprising: retrieving one or more contact groups from the recorded email sending data when the user composes a new email; and, presenting to the user the retrieved one or more contact groups as possible sending lists.

According to a further aspect of the present invention, there is provided an apparatus for automatically creating contact groups, comprising a recording module configured to track an email sending history of a user, and automatically record email sending data, wherein the recorded email sending data comprises contact groups, each of which consists of the email addresses of all the receivers of a sent email and corresponding receiving types.

According to still another aspect of the present invention, there is provided an apparatus for suggesting an email sending list to a user, comprising: a retrieving module for retrieving one or more contact groups from the recorded email sending data when the user composes a new email; and, a presenting module for presenting to the user the retrieved one or more contact groups as possible sending lists.

### BRIEF DESCRIPTION OF THE SEVERAL VIEWS OF THE DRAWINGS

FIG. 1 shows a method for automatically creating communication groups according to an embodiment of the present invention.

FIG. 2 shows an exemplary structure of an email sending data record.

FIG. 3 shows an example of indexed email sending data records containing communication groups.

FIG. 4 shows a method for suggesting an email sending list to a user according to an embodiment of the present invention.

FIG. 5 shows an example of a user interface in which ordered communication groups are suggested to a user based on input of the user.

FIG. 6 shows an apparatus for automatically creating communication group and an apparatus for suggesting an email sending list to a user according to embodiments of the present invention.

### DETAILED DESCRIPTION

Embodiments of the present invention will be described below. In the following description, numerous specific details are set forth in order to make the present invention be more fully understood. However, it is obvious for a person skilled in the art that the implementation of the disclosure may not have these specific details. In addition, it should be understood that the disclosure is not limited to the particular embodiments described herein. Rather, it is contemplated to implement or practice the disclosure by using any combination of the following features and elements, regardless of whether they involve different embodiments. Therefore, the following aspects, features, embodiments and advantages are only used for illustration and should not be regarded as elements or limitations of the attached claims, unless indicated explicitly otherwise in the claims.

The core concept of the present invention consists in that the email sending history of a user is tracked, and by using the email sending history of the user, the disclosed apparatus can create contact groups for a user automatically, and these contact groups can be indexed according to contact information such as the name and email address of a first recipient. When a user composes a new email, the apparatus of the present invention will suggest a possible contact group list to the user according to the recipient name or email address selected or input by the user. The suggested contact group list may be ordered according to the email sending times and/or number of times of email sendings corresponding to the contact groups.

Embodiments of the invention provide numerous advantages over known solutions. For example, compared to the technical solution in which a single contact is suggested when a user composes an email, whole contact groups can be suggested to the user. Thus, the user can select a suitable contact group, without need to input or select each contact one by one, which is quicker and lowers the possibility that a user mistakenly select contacts having similar names or email addresses.

In another example, compared to the technical solution in which communication groups created in advance are used, the communication groups of the disclosure are automatically created by tracking email sending history without needing a user to create communication groups manually in advance. Such communication groups automatically changes along with the work situation of the user. In addition, when the user composes an email, he can see each receiver in a communication group, instead of only the name of the communication group, thus facilitating the user to check and confirm. Other advantages exist, and the above examples are not intended to be comprehensive.

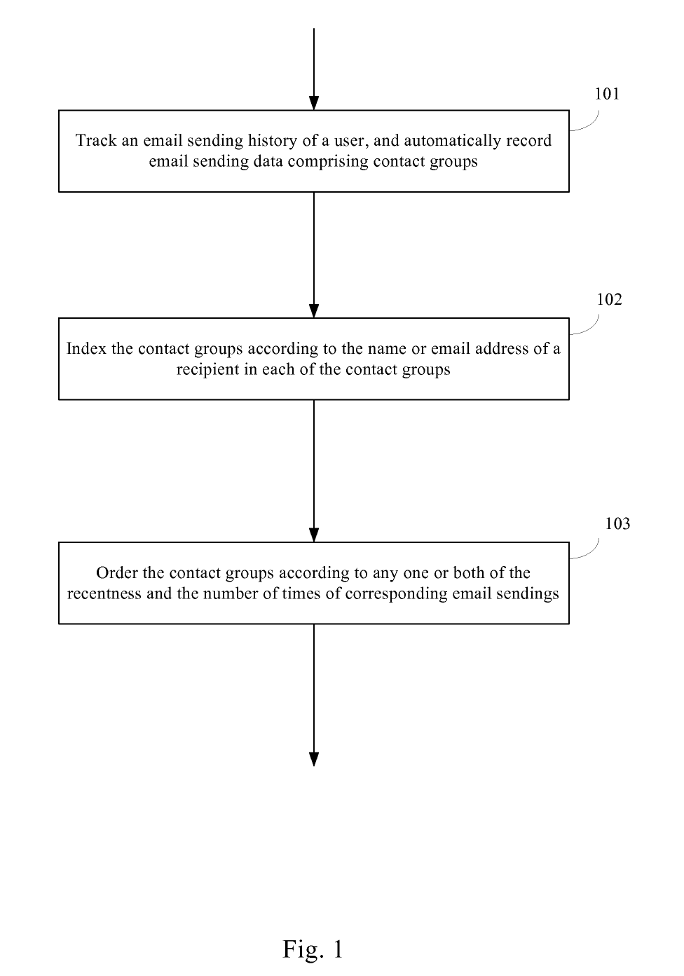

A method for automatically creating contact groups according to an embodiment of the present invention will be described below with reference to FIG. 1. As shown in the figure, the method comprising the following steps:

At step 101, the email sending history of a user is tracked, and email sending data are recorded, wherein the recorded email sending data contain contact groups, each of which consist of the email addresses of all receivers of the sent email and the corresponding receiving types. That is to say, in the embodiment of the present invention, each email sending data record formed by recording email sending data comprises: the receiving type of each receiver in the email sending list this time (such as To, Cc, Bcc), the name of the each receiver, and the email address of the each receiver. In addition, in an embodiment of the present invention, each record further comprises such data as the timestamp of the email sending. One or more sets of a receiving type, receiver name and receiver email address contained in each email sending data record constitute a contact group. The email sending data records can be recorded in any data structure known by a person skilled in the art, such as in a relational database or a linked list. In addition, the contact groups contained in the email sending data can either be owned exclusively by the user, in which case the email sending data are preferably stored in the mail client program of the user, or be shared by a plurality of users such as all users in an enterprise or department, in which case the email sending data are preferably stored in a central database, which is used for storing email sending data from the email sending histories of a set of users.

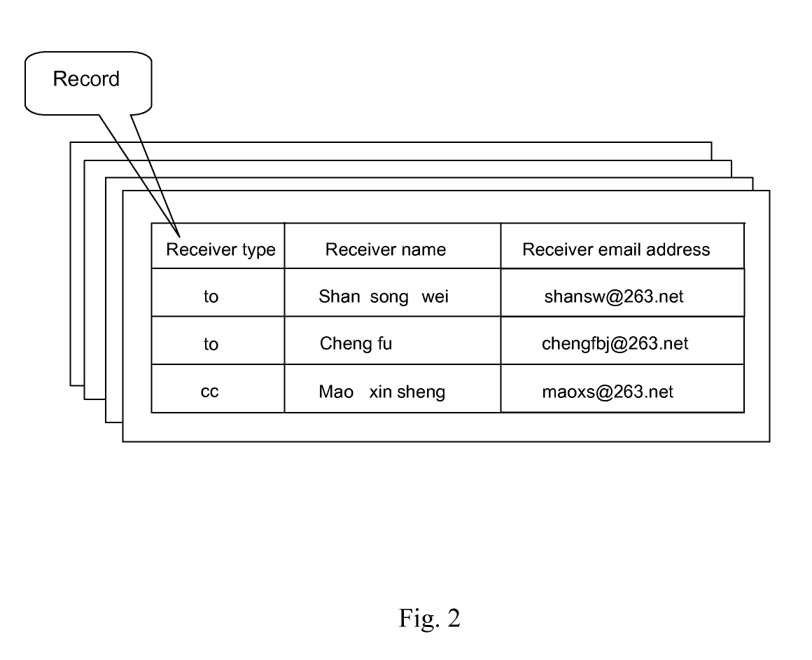

FIG. 2 shows an exemplary structure of an email sending data record, wherein an exemplary record records the following contact group from a sending list of an email sending: a receiving type “TO”, a receiver name “Shan Song Wei”, and a receiver email address “shansw@263.net”; a receiving type “TO”, a receiver name “Cheng Fu”, and a receiver email address “chengfbj@263.net”; and, a receiving type “Cc”, a receiver name “Mao Xin Shen”, and a receiver email address “maoxs@263.net”;

Since a user may send emails to a same group of receivers at different times, in an embodiment of the present invention, one email sending data record can be generated for each email sending, thus the apparatus of the disclosure may store a set of email sending data records having identical contact groups. Identical contact group mean that not only the contact groups have completely identical receiver lists, but also the receiving types of the receivers are completely identical. For example, Sam first sends an email to shansw@263.net, and carbon copies it to maoxs@263.net; later, Sam sends another email to shansw@263.net, and carbon copies it to maoxs@263.net. Thus, the apparatus according to the disclosure will generate two email sending data records, which will have identical contact groups. In one embodiment, identical contact groups can be regarded as a same contact group.

In another embodiment, only one email sending data record containing a corresponding contact group is generated for a set of email sending having a same sending list, and the email sending data record can further contain such information as the number of times that the emails has been sent and/or the timestamp of the each or last email sending.

Returning to FIG. 1, at optional step 102, contact groups are indexed according to the name or email address of a recipient in the contact groups. That is, email sending data records are indexed according to the name or email address of a receiver whose receiving type is “To” in the contact group contained in each email sending data record. For example, if the email sending data record of a user is stored in a relational DATABASE, then the following two fields “receiver name” and “receiver email address” can be indexed.

According to one embodiment, contact groups are indexed according to the name or email address of the first recipient in each contact group. That is, email sending data records are indexed according to the name or email address of the first receiver whose receiving type is “To” in the contact group contained in each email sending data record.

For example, for the contact group: to:shans@263.net, chengfbj@263.net; cc:maoxs@263.net, indexing will be performed according to shansw@263.net, instead of chengfbj@263.net or maoxs@263.net. Of course, it is also contemplated that contact groups can be indexed according to a plurality of receiver or a plurality of receiving types.

Thus, each index item will point to a chain of one or any number of different contact groups having the same first or other recipients, and each contact group corresponds to one or more email sending data records.

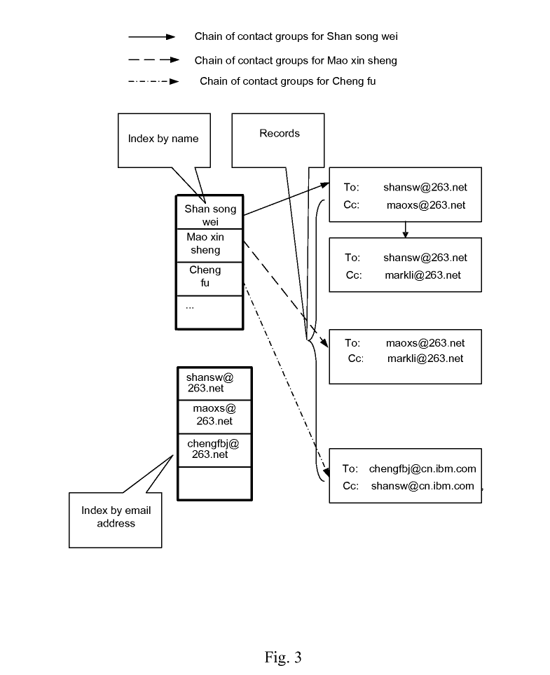

For example, FIG. 3 shows an example of indexed email sending data records containing contact groups. As shown in the figure, a contact group chain with the index of “Shan Song Wei” comprises two contact groups: To: shansw@263.net, Cc: maoxs@263.net and To: shansw@263.net, Cc:markli@263.net. A contact group chain with the index of “Mao Xin Sheng” contains one contact group: To: maoxs@263.net, Cc: markli@263.net. A contact group chain with the index of “Cheng Fu” comprises one contact group: To: chengfbj@263.net, Cc: shansw@263.net.

Returning to FIG. 1, at optional step 103, contact groups are ordered according to any one or both of the recentness and the number of times of corresponding email sendings, so as to determine the order among the contact groups in a contact group chain indexed by a same recipient name or email address. Of course, in some contemplated embodiments, the contact groups contained in all the recorded email sending data may be ordered.

As mentioned above, each contact group in a contact group chain indexed by a same index item has a corresponding email sending data record list. So, the order of the contact groups can be determined according to the following two factors: the timestamp of each email sending data record owned by each contact group; and, the total number of email sending data records owned by each contact group, which total number reflects the number of times that emails have been sent using the contact group as the sending list.

The order among contact groups indexed by a same recipient name or email address can be determined by using the following method.

First, a weight of each email sending data record in each contact group is determined. The weight of each record can be determined according to the sending time of the record. For example, the weight of each record can be determined by using the following table according to the number of days passed since the creation of the record. The number of days passed since the creation of each record can be determined according to the timestamp of each record and the current time.

| The number of days passed | Weight |
|---|---|
| <1 week | 1 |
| >1 week and <2 weeks | ¾ |
| >2 weeks and <1 month | ⅗ |
| >1 month and <6 months | ⅓ |
| >6 months | 1/10 |
| >2 years | 1/100 |

Then, an ordering score of each contact group is calculated according to the weight of the records corresponding to each contact group. The ordering score of each contact group is calculated by using the following formula:

$$Score = {\sum }_{i = 1}^{N} weight ( Ri )$$

wherein, Score is the ordering score of a contact group which has N records, Ri is the i-th record owned by the contact group, and weight(Ri) is the weight of the i-th record.

Of course, the above method for determining the order among contact groups is only an illustration instead of limitation to the disclosure's scope. For example, in other embodiments, each email sending data record may have other weight values; and, the ordering score of each contact group can be calculated by using other formulas, such as only considering the recentness of the time of the last email sending data record. All of these variations are within the scope of the disclosure.

In addition, according to some embodiments, the method for automatically creating contact groups may exclude the ordering step 103. Instead, the ordering step can be included in a method for suggesting an email sending list to a user as described below.

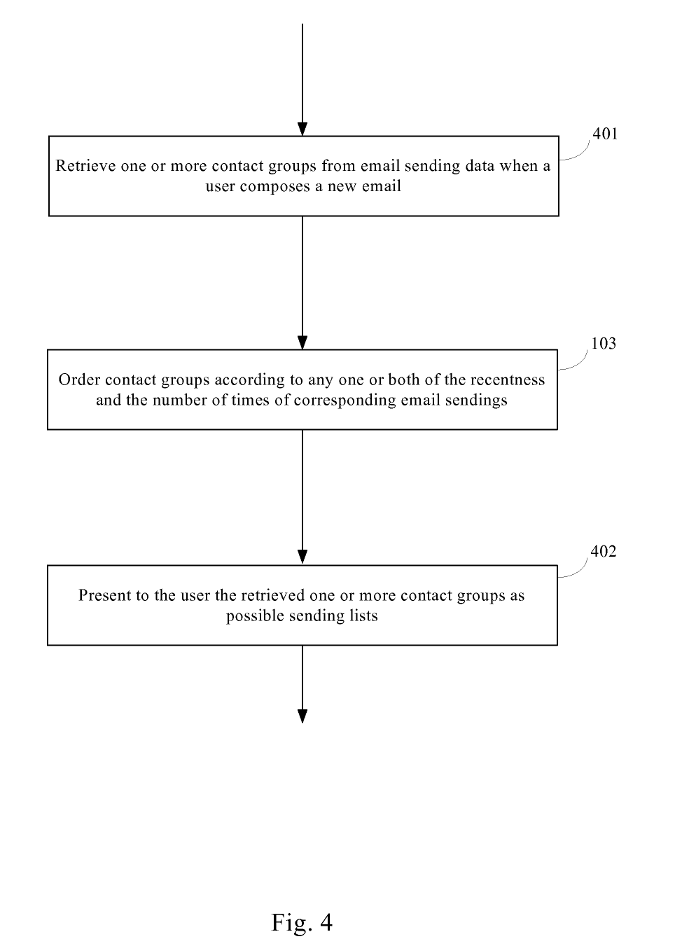

A method for suggesting an email sending list to a user according to an embodiment of the present invention will be described below with reference to FIG. 4.

As shown in the figure, at step 401, when a user composes a new email, one or more contact groups are retrieved from the recorded email sending data as described above.

According to an embodiment, the step comprises: according to all or part of a recipient name or email address input by a user in a recipient field of an email, retrieving, from the email sending data, contact groups having corresponding all or part of recipient name or email address. That is, the apparatus of the disclosure will use all or part of the recipient name or email address input or selected by a user to retrieve contact groups having a matching recipient name or email address.

According to an embodiment, if contact groups have been indexed according to recipient names or email addresses as described above, then the contact groups can be easily searched for by using indexes, thus retrieving one or more contact group chains pointed to by one or more index items matching all or part of a recipient name or email address input or selected by the user.

According to an embodiment, if the retrieved contact groups have not been ordered there among (i.e., the optional step 103 has not been executed in the above method for automatically creating contact groups) then the optional step 103 can be executed at this time. That is, after matching index items are found in the recorded email sending data according to the selection or input of the user and then the contact group chain(s) pointed to by the index items are retrieved, the contact groups in the contact group chain(s) can be ordered. Alternatively, in case that the email sending data have no index, after a plurality of matching contact groups are found directly according to the selection or input of the user, the plurality of contact groups can be ordered. For further details of the ordering step 103, refer to the above description.

At step 402, the retrieved one or more contact groups are presented to the user as possible sending list(s). If the contact groups are ordered as described above, then the ordered contact groups are presented to the user as possible sending lists. In addition, either all the ordered contact groups can be presented, or part of the ordered contact groups, such as the first five contact groups, can be presented.

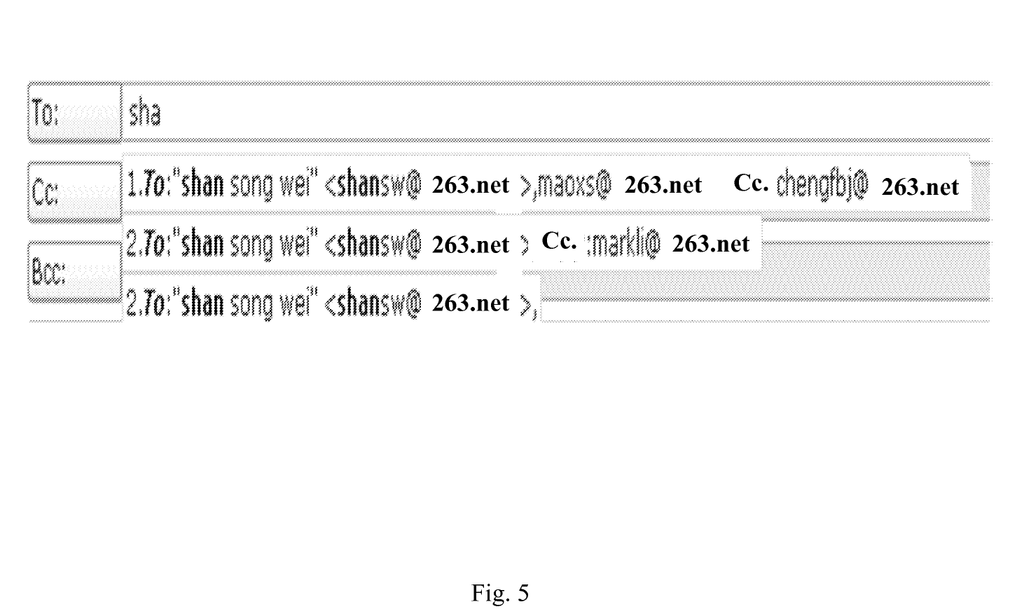

FIG. 5 shows an example of a user interface in which ordered communication groups are suggested to a user based on the input of the user. As shown in the figure, after a user inputs “sha” in a recipient input field, the apparatus according to the present invention will present to the user 3 contact groups:
1. To:“shan song wei” shansw@263.net, maoxs@263.net; Cc: chengfbj@263.net□
2. To:“shan song wei” shansw@263.net, Cc: markli@263.net□
3. To: “shan song wei” shansw@263.net□
   The user can select any contact group therefrom as the sending list for this email sending. Thus, when the user selects a certain presented contact group by clicking a mouse cursor, for example, the contact group will be input into the email composing interface automatically as a complete sending list, that is, the email addresses of the receivers in the contact group will be automatically input into the receiver fields of corresponding receiving types in the email composing interface.

Of course, after the contact group is automatically input into the email composing interface as a complete sending list, the user may modify, delete or re-input the sending list.

The above has been described a method for automatically creating contact groups and a method for suggesting an email sending list to a user according to the embodiments of the disclosure. It should be pointed out that the above description is only an illustration instead of limitation to the disclosure. In other embodiments, the methods may have more, less or different steps, and the order among steps may be different from that described. Further, some steps may be divided into smaller steps, or several steps may be merged into a larger step. For example, in some embodiments, either or both of the indexing step 102 and the ordering step 103 may be omitted, and so on. All of these variations are within the spirit and scope of the disclosure.

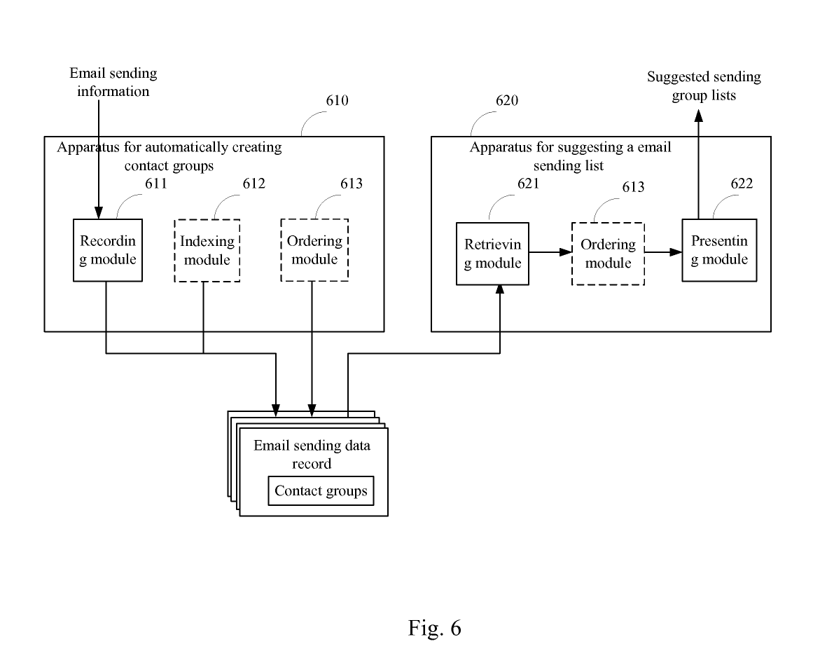

An apparatus 610 for automatically creating contact groups and an apparatus 620 for suggesting an email sending list to a user according to an embodiment of the present invention will be described below with reference to FIG. 6. The apparatuses may be used to implement the above described methods according to the embodiments of the disclosure. For brevity, some details overlapping with the above description are omitted in the following description.

As shown in FIG. 6, an apparatus 610 for automatically creating contact groups according to an embodiment of the present invention comprises a recording module 611.

The recording module 611 is configured to track the email sending history of a user, and automatically recording email sending data, wherein the recorded email sending data contain contact groups each of which consist of the email addresses of all receivers of a sent email and corresponding receiving types.

According to an embodiment, the apparatus 610 further comprises an optional indexing module 612 configured to index contact groups according to the names and email addresses of recipients in the contact groups. According to a further embodiment, the indexing module is configured to index the contact groups according to the name and email address of the first recipient in each of the contact groups.

According to an embodiment, the email sending data further comprises the timestamp of an email sending, and the apparatus 610 further comprises an optional ordering module 613 configured to order contact groups according to any one or both of the recentness and the number of times of corresponding email sendings.

According to some embodiments, the ordering module 613 is not included in the apparatus 610 for creating contact groups, and instead is included in an apparatus 620 for suggesting an email sending list to a user as described below. In addition, according to some other embodiments, both the apparatus 610 and 620 do not include the ordering module 613.

According to an embodiment, the email sending data are stored in a central database shared by a plurality of users.

As shown in FIG. 6, the apparatus 620 for suggesting an email sending list to a user comprises a retrieving module 621 and a presenting module 622.

The retrieving module 621 is configured to retrieve one or more contact groups from the recorded email sending data when a user composes a new email.

The presenting module 622 is configured to presenting the retrieved one or more contact groups to the user as possible sending lists.

According to an embodiment, the apparatus 620 for suggesting an email sending list to a user further comprises an optional ordering module 613 configured to order the contact groups retrieved by the retrieving module 621.

According to an embodiment, the presenting module 622 is further configured to present the ordered contact groups to the user. The contact groups may be ordered by the ordering module 613 in the apparatus 620 or 610.

According to an embodiment, the presenting module 622 is further configured to, according to all or part of a recipient name or email address input by a user in a recipient field of an email, present to the user contact groups having corresponding all or part of a recipient name or email address.

In one embodiment, the apparatus 610, 620 is integrated in an email client program, as part thereof. In another embodiment, the apparatus 610, 620 may also interact with the email client program as separate apparatuses. The apparatus 610, 620 can be implemented in any computer program product (e.g., software, firmware, etc.), which can be digitally encoded in a physical storage medium, such as a nonvolatile or volatile memory. The computer program product can be processed by a processer (e.g., CPU) linked to a volatile and/or non volatile memory via a bus. The computer program product can execute in a single machine or in multiple different machines a distributed computing environment.

The above has been described the apparatus 610 for automatically creating contact groups and the apparatus 620 for suggesting an email sending list to a user according to an embodiment of the disclosure. It should be pointed out that the apparatuses 610, 620 as described and shown are only illustration instead of imitation to the disclosure. According to other embodiments, the apparatus may have more, less or different modules, and the connection, containment and data input/output relationships among the modules may be different from that described and shown. Further, some modules may be divided into smaller modules, each of which is used for executing part of the functions of the original module, or some modules may be merged into a larger module for executing the functions of the original modules. In addition, the names of the modules are only for the convenience of narration, instead of imitation to the disclosure. For example, in some embodiments, either or both of the indexing module 612 and the ordering module 613 may be omitted. All of these variations are within the spirit and scope of the disclosure.

Embodiments of the present invention can be implemented by hardware, software, firmware, and/or a combination thereof. Embodiment of the present invention can be implemented in a computer system in a centralized mode or in a distributed mode, in which, different components are distributed in several interconnected computer systems. Any computer system or other apparatus suitable for executing the methods described herein is applicable. A typical combination of hardware and software may be a general-purpose computer system having a computer program, which, when being loaded and executed, controls the computer system to execute the methods of the disclosure and constitute the apparatus of the disclosure.

Embodiments of the present invention can also be embodied in a computer program product, which comprises all the features enabling the methods described herein to be implemented, and when being loaded into the computer system, can execute these methods.

While the present invention is shown and described with reference to numerous embodiments, a person skilled in the art can understand that various changes in form and detail can be made thereto without departing from the spirit and scope of the disclosure.

What is claimed is:

1. A method for automatically creating contact groups comprising:
tracking an email sending history of a user, and automatically recording email sending data, wherein the recorded email sending data comprises contact groups, each of which consists of the email addresses of all the receivers of a sent email and corresponding receiving types.

2. The method according to claim 1, further comprising indexing the contact groups according to the name or email address of a recipient in each of the contact groups.

3. The method according to claim 2, wherein indexing the contact groups according to the name or email address of a recipient in each of the contact groups comprises:
indexing the contact groups according to the name or email address of the first recipient in each of the contact groups.

4. The method according to claim 1, wherein the email sending data further comprises the timestamps of email sendings, and the method further comprises ordering contact groups according to any one or both of the recentness and the number of times of corresponding email sendings.

5. The method according to claim 1, wherein the email sending data are stored in a central database shared by a plurality of users.

6. A method for suggesting an email sending list to a user, comprising:
retrieving one or more contact groups from a recorded email sending data when a user composes a new email, wherein the recoded email sending data comprises contact groups, each of which consists of the email addresses of all the receivers of a sent email and corresponding receiving types, wherein the recorded email sending data is maintained by executing computer program products that track en email sending history of the user; and,
presenting to the user the retrieved one or more contact groups as possible sending lists.

7. The method according to claim 6, wherein presenting to the user the retrieved one or more contact groups as possible sending lists comprises:
presenting ordered contact groups to the user.

8. The method according to claim 6, wherein the retrieving one or more contact groups from the recorded email sending data comprises:
according to all or part of a recipient name or email address input by a user in the recipient field of an email, retrieving, from the email sending data, one or more contact groups having corresponding all or part of a recipient name or email address.

9. An apparatus for automatically creating contact groups, comprising:
a recording module configured to track an email sending history of a user, and automatically record email sending data, wherein the recorded email sending data comprises contact groups, each of which consists of the email addresses of all the receivers of a sent email and corresponding receiving types.

10. The apparatus according to claim 9, further comprising:
an indexing module configured to index the contact groups according to the name or email address of a recipient in each of the contact groups.

11. The apparatus according to claim 10, wherein the indexing module is further configured to index the contact groups according to the name or email address of the first recipient in each of the contact groups.

12. The apparatus according to claim 9, wherein the email sending data further comprises timestamps of email sendings, and the apparatus further comprises an ordering module configured to order contact groups according to any one or both of the recentness and the number of times of corresponding email sendings.

13. The apparatus according to claim 9, wherein the email sending data are stored in a central database shared by a plurality of users.

14. An apparatus for suggesting an email sending list to a user, comprising:
a retrieving module configured to retrieve one or more contact groups from a recorded email sending data when a user composes a new email, wherein the recoded email sending data comprises contact groups, each of which consists of the email addresses of all the receivers of a sent email and corresponding receiving types, wherein the recorded email sending data is maintained by executing computer program products that track en email sending history of the user; and
a presenting module configured to present to the user the retrieved one or more contact groups as possible sending lists.

15. The apparatus according to claim 14, wherein the presenting module is further configured to present ordered contact groups to the user.

16. The apparatus according to claim 14, wherein the retrieving module is further configured to:
according to all or part of a recipient name or email address input by a user in the recipient field of an email, retrieve, from the email sending data, one or more contact groups having corresponding all or part of a recipient name or email address.
